(19) United States
(12) Patent Application Publication
(10) Pub. No.: US 2010/0304092 A1
(43) Pub. Date: Dec. 2, 2010

(54) METHOD OF MANUFACTURING DICING DIE-BONDING FILM

(76) Inventors: Yasuhiro Amano, Osaka (JP); Takeshi Matsumura, Osaka (JP); Kouichi Inoue, Osaka (JP)

Correspondence Address: KNOBBE MARTENS OLSON & BEAR LLP, 2040 MAIN STREET, FOURTEENTH FLOOR, IRVINE, CA, 92614, US

(21) Appl. No.: 12/744,113

(22) PCT Filed: Aug. 12, 2009
(86) PCT No.: PCT/JP2009/064238

§ 371 Date: Jul. 8, 2010

(30) Foreign Application Priority Data
Sep. 1, 2008 (JP) 2008-223742

(51) Int. Cl. B32B 7/10; B32B 37/02; B32B 3/00

(52) U.S. Cl. 428/172; 156/60

(57) ABSTRACT

A method of manufacturing a dicing die-bonding film having excellent adhesive properties during a dicing step and excellent peeling properties during a pickup. A method of manufacturing a dicing die-bonding film comprising a pressure-sensitive adhesive layer and an adhesive layer laminated sequentially on a base material, the method including the steps of forming the adhesive layer on a releasing film, the film containing an inorganic filler, having an arithmetic mean roughness Ra of 0.015 to 1 μm, and having an uneven surface and bonding the pressure-sensitive adhesive layer and the adhesive layer provided on the base material under the conditions of a temperature of 30 to 50° C. and a pressure of 0.1 to 0.6 MPa and making the contact area of the pressure-sensitive adhesive layer and the adhesive layer be in the range of 35 to 90% to the bonding area.

### TECHNICAL FIELD

The present invention relates to a method of manufacturing a dicing die-bonding film for supplying, to the dicing of a work (such as a semiconductor wafer), an adhesive for fixing a chip-form work (such as a semiconductor chip) and an electrode member to each other in the state that the adhesive is attached to the work before the dicing. The present invention also relates to a dicing die-bonding film obtained by the process.

### BACKGROUND ART

A semiconductor wafer (workpiece) in which a circuit pattern is formed is diced into semiconductor chips (chip-shaped workpiece) (a dicing step) after the thickness thereof is adjusted as necessary by backside polishing. The semiconductor chip is then fixed onto an adherend such as a lead frame with an adhesive (a mounting step), and then transferred to a bonding step. In the mounting step, the adhesive has been applied onto the lead frame or the semiconductor chip. However, with this method, it is difficult to make the adhesive layer uniform and a special apparatus and a long period of time become necessary in the application of the adhesive. For this reason, a dicing die-bonding film is proposed that adhesively holds the semiconductor wafer in the dicing step and also imparts an adhesive layer for fixing a chip that is necessary in the mounting step (for example, see Patent Document 1).

The dicing die-bonding film described in Patent Document 1 is composed of an adhesive layer that is formed on a supporting base material so that it can be peeled. That is, the dicing die-bonding film is made so that after the semiconductor wafer is diced while being held by the adhesive layer, the semiconductor chip is peeled together with the adhesive layer by stretching the supporting base material, the semiconductor chips are individually recovered, and then they are fixed onto an adherend such as a lead frame with the adhesive layer interposed therebetween.

Good holding power toward the semiconductor wafer so that a dicing failure, a dimensional error, etc. do not occur and good peelability in which the semiconductor chip after dicing can be peeled from the supporting base material integrally with the adhesive layer are desired for the adhesive layer of this type of the dicing die-bonding film. However, it has been by no means easy to balance both these characteristics. Particularly, when a large holding power is required for the adhesive layer such as in the method of dicing the semiconductor wafer with a rotary round blade, it has been difficult to obtain a dicing die-bonding film that satisfies the above characteristics.

Therefore, in order to overcome such problems, various improvement methods have been proposed (for example, see Patent Document 2). In Patent Document 2, a method of interposing a pressure sensitive adhesive layer that can be cured by ultraviolet rays between the supporting base material and the adhesive layer, decreasing the adhering force between the pressure sensitive adhesive layer and the adhesive layer by curing this with ultraviolet rays after dicing, and facilitating picking up the semiconductor chip by peeling both layers is proposed.

However, as a semiconductor wafer becomes larger and thinner, it is difficult to satisfy the high adhesive properties that are necessary during dicing and the peeling properties that are necessary during pickup at the same time, and it has been difficult to peel a semiconductor chip with an adhesive from a dicing tape. As a result, there is a problem of damage caused by a pickup failure or a deformation of the chip.

Further, an ultraviolet-ray curing-type dicing tape may be used depending on the type of dicing die-bonding film. In the case of this ultraviolet-ray curing-type dicing tape, the adhering force may increase with time by reacting with an uncured resin in the pressure-sensitive adhesive layer. In this case, it becomes difficult to pick up the semiconductor chip with an adhesive from the dicing tape, and the semiconductor chip with an adhesive is disposed without being able to be peeled and removed. As a result, the production cost increases and the decrease of the yield is brought about.

Examples of a method of controlling the balance of the adhesive properties and the peeling properties between the pressure-sensitive adhesive layer and the adhesive layer include methods of mixing an inorganic filler into the adhesive layer and suitably adjusting its mixing amount. However, the optimum mixing amount of the inorganic filler changes depending on its cohesion state, its particle size distribution, etc. Therefore, application on an industrial scale is tried normally after the optimum mixing ratio of a binder is experimentally determined in advance depending on the properties of the inorganic filler that is used. However, the quantity that is used on an experimental scale differs from that on an industrial scale, and a problem of representativeness of samples occurs in the evaluation with a small quantity. As a result, in manufacturing on an industrial scale, the surface roughness of the adhesive layer becomes nonuniform across lots of the filler or within each lot of the filler, and the pickup properties deteriorate even when the application is performed with a fixed particle size and a fixed mixing condition. In addition, various difficulties occur in the manufacturing process and complications increase, such that modification of the application conditions of an adhesive composition solution during the formation of the adhesive layer and modification of the pasting condition with the pressure-sensitive adhesive layer become necessary.

### Prior Technical Documents

### Patent Documents

[Patent Document 1] Japanese Patent Application Laid-Open No. 60-57642

[Patent Document 2] Japanese Patent Application Laid-Open No. 2-248064

### DISCLOSURE OF THE INVENTION

### Problems to be Solved by the Invention

The present invention has been performed in view of the above-described problems, and its object is to provide a method of manufacturing a dicing die-bonding film that is capable of manufacturing a dicing die-bonding film having excellent adhesive properties during a dicing step and excellent peeling properties during a pickup step without modifying its design even on an industrial scale, and a dicing die-bonding film that can be obtained with this method.

### Means for Solving the Problems

The present inventors have investigated a method of manufacturing a dicing die-bonding film and a dicing die-bonding film that can be obtained with this method to solve the above-described conventional problems. As a result, they found that a dicing die-bonding film having good adherability and peeling properties between a pressure-sensitive adhesive layer and an adhesive layer even when it is manufactured on an industrial scale can be obtained by controlling not only the mixing amount of an inorganic filler that is mixed into the adhesive layer but also the contact area between the two layers, to complete the present invention.

That is, in order to solve the above-mentioned problems, the present invention relates to a method of manufacturing a dicing die-bonding film comprising a pressure-sensitive adhesive layer and an adhesive layer laminated sequentially on a base material, the method including the steps of forming the adhesive layer on a releasing film, the film containing an inorganic filler, having an arithmetic mean roughness Ra of 0.015 to 1 μm, and having an uneven surface and bonding the pressure-sensitive adhesive layer and the adhesive layer provided on the base material under the conditions of a temperature of 30 to 50° C. and a pressure of 0.1 to 0.6 MPa and making the contact area of the pressure-sensitive adhesive layer and the adhesive layer be in the range of 35 to 90% to the bonding area.

According to the above-described method, the pressure-sensitive adhesive layer and the adhesive layer can adhered to each other in multipoint contact or in an island-like contact state by forming the adhesive layer having an uneven surface and an arithmetic mean roughness Ra of 0.015 to 1 μm and by pasting the adhesive layer and the pressure-sensitive adhesive layer under conditions of a temperature of 30 to 50° C. and a pressure of 0.1 to 0.6 MPa. Further, by making the contact area of both layers be 90% or less of the pasting area, the contact are with the pressure-sensitive adhesive layer increases, and therefore the adherability can be prevented from becoming excessively large, and the pickup properties can be prevented from deteriorating. On the other hand, by making the contact area be 35% or more, the contact area with the pressure-sensitive adhesive layer decreases, and therefore the peeling properties can be prevented from being excessively large, and chip fly of a semiconductor chip during dicing can be prevented from being generated.

That is, with the above-described method, a dicing die-bonding film can be obtained in which the balance of the adherability during a dicing step and the peeling properties during a pickup step is controlled well between the pressure-sensitive adhesive layer and the adhesive layer. Further, by adjusting the mixing amount of the inorganic filler, a substantial design modification of the application conditions of an adhesive composition solution during the formation of the adhesive layer, the pasting condition with the pressure-sensitive adhesive layer, etc. can be avoided even when the manufacturing is performed on an industrial scale compared with the case of controlling the adhesive properties and the peeling properties between the pressure-sensitive adhesive layer and the adhesive layer. As a result, complications during the manufacturing process can be decreased.

In the above-described process, it is preferable that the step of forming the adhesive layer includes the steps of forming a coating layer by applying an adhesive composition solution containing the inorganic filler on the releasing film and drying by blowing dry air having an amount of air of 5 to 20 m/min onto the coating layer under conditions of a drying temperature of 70 to 160° C. and a drying time of 1 to 5 min. With this, an adhesive layer can be formed having an uneven pasting surface with a pressure-sensitive adhesive layer and an arithmetic mean roughness Ra of 0.015 to 1 μm.

In the above-described process, it is preferable that the mixing amount of the inorganic filler is 20 to 80 parts by weight to 100 parts by weight of an organic resin component in the adhesive layer. By making the mixing amount of the inorganic filler be 20 parts by weight or more to 100 parts by weight of an organic resin component of the adhesive layer, the decrease of heat resistance can be prevented, curing of the adhesive layer can be prevented even when it is exposed to a thermal history of high temperature for a long time, and a decrease of its fluidity and embedding properties can be prevented. On the other hand, by making the mixing amount be 80 parts by weight or less, the tensile modulus of the adhesive layer can be prevented from becoming too high, and embedding properties to the unevenness on the pasting surface can be prevented from decreasing due to stress relaxation of the cured adhesive becoming difficult even during a sealing step of a semiconductor device with a sealing resin.

In the above-described process, it is preferable that the inorganic filler having an average particle size of 0.1 to 5 μm is used. When the average particle size of the inorganic filler is less than 0.1 μm, it becomes difficult to make the arithmetic mean roughness Ra in the adhesive layer be 0.015 μm or more. On the other hand, when the average particle size exceeds 5 μm, it becomes difficult to make Ra be less than 1 μm.

In the above-described process, it is preferable that the drying of the coating layer is performed by increasing the drying temperature gradually as the drying time passes. With a drying method in which a drying temperature is increased in stages, the generation of pin holes on the surface of the applied layer right after the application of the adhesive composition solution can be prevented.

In the above-described process, it is preferable that the arithmetic mean roughness Ra of the pressure-sensitive adhesive layer before bonding to the adhesive layer is in the range of 0.015 to 0.5 μm.

That is, in order to solve the above-mentioned problems, the present invention relates to a dicing die-bonding film comprising a pressure-sensitive adhesive layer and an adhesive layer sequentially laminated on a base material, wherein the adhesive layer contains an inorganic filler, has an uneven bonding surface before bonding to the pressure-sensitive adhesive layer, and has an arithmetic mean roughness Ra is 0.015 of 1 μm, and wherein the contact area of the bonding surface is in the range of 35 to 90% to the bonding surface.

Because the pasting surface in the adhesive layer with the pressure-sensitive adhesive layer is uneven in the above-described configuration, the adhesive layer can adhered to the pressure-sensitive adhesive layer in multipoint contact or in an island-like contact state by pasting. Further, by making the arithmetic mean roughness Ra be 0.015 to 1 μm on the pasting surface of the adhesive layer, the contact area with the pressure-sensitive adhesive layer is made to be in a range of 35 to 90% to the pasting area. With such a configuration, a dicing die-bonding film can be obtained having an excellent balance of the adherability during a dicing step and the peeling properties during a pickup step between the pressure-sensitive adhesive layer and the adhesive layer.

In the above constitution, it is preferable that the mixing amount of the inorganic filler is 20 to 80 parts by weight to 100 parts by weight of an organic resin component in the adhesive layer. By making the mixing amount of the inorganic filler be 20 parts by weight or more, a decrease of the heat resistance can be prevented, curing of the adhesive layer can be prevented even when it is exposed to a thermal history of high temperature for a long time, and a decrease of its fluidity and embedding properties can be prevented. On the other hand, by making the mixing amount be 80 parts by weight or less, the tensile modulus of the adhesive layer can be prevented from becoming too high, and embedding properties to the unevenness on the pasting surface can be prevented from decreasing due to stress relaxation of the cured adhesive becoming difficult even during a sealing step of a semiconductor device with a sealing resin.

In the above constitution, it is preferable that the inorganic filler having an average particle size of 0.1 to 5 μm is used. When the average particle size of the inorganic filler is less than 0.1 μm, it becomes difficult to make the arithmetic mean roughness Ra in the adhesive layer be 0.015 μm or more. On the other hand, when the average particle size exceeds 5 μm, it becomes difficult to make Ra be less than 1 μm.

In the above constitution, it is preferable that the arithmetic mean roughness Ra of the pressure-sensitive adhesive layer before bonding to the adhesive layer is in the range of 0.015 to 0.5 μm.

### BRIEF DESCRIPTION OF THE DRAWINGS

FIG. 1 is a cross-sectional schematic drawing showing a dicing die-bonding film according to one embodiment of the present invention.

FIG. 2 is a cross-sectional schematic drawing showing a dicing die-bonding film according to another embodiment of the present invention.

FIG. 3 is a cross-sectional schematic drawing showing an example of mounting a semiconductor chip with an adhesive layer of the dicing die-bonding film according to the present invention.

FIG. 4 is a cross-sectional schematic drawing showing an example of three-dimensionally mounting a semiconductor chip with the adhesive layer.

FIG. 5 is a cross-sectional schematic drawing showing an example of three-dimensionally mounting two semiconductor chips with a spacer using the adhesive layer.

### BEST MODE FOR CARRYING OUT THE INVENTION

(Method of Manufacturing Dicing Die-Bonding Film)

A method of manufacturing a dicing die-bonding film according to the present embodiment is described below by using a dicing die-bonding film in which a pressure-sensitive adhesive layer and an adhesive layer are laminated sequentially on a base material as an example.

First, the method of manufacturing a dicing die-bonding film according to the present embodiment includes at least a step of forming an adhesive layer on a releasing film and a step of pasting a pressure-sensitive adhesive layer that is formed on the base material to the adhesive layer.

Examples of the method of forming the adhesive layer include methods of performing a step of forming a coating layer by applying an adhesive composition solution (details are described later) containing an inorganic filler on the releasing film and a step of drying the coating layer.

The method of applying the adhesive composition solution is not especially limited, and examples thereof include methods of applying using a comma coat method, a fountain method, a gravure method, etc. The thickness of coating can be suitably set so that the thickness of the adhesive layer that can be finally obtained after drying the coating layer becomes in a range of 5 to 100 μm. Further, the viscosity of the adhesive composition solution is not especially limited, and it is preferably 400 to 2500 mPa·s, and more preferably 800 to 2000 mPa·s.

The releasing film is not especially limited, and a conventionally known one can be used. A specific example is a film in which a releasing coat layer such as a silicone layer is formed on the pasting surface with the adhesive layer in a substrate of the releasing film. Further, examples of the substrate of the releasing film are paper such as glassine paper and a resin film made of polyethylene, polypropylene, polyester, etc.

The drying of the coating layer is performed by blowing dry air onto the coating layer. Examples of the blowing of the dry air are a method of blowing so that the blowing direction becomes parallel to the conveying direction of the releasing film and a method of blowing so that the blowing direction becomes perpendicular to the surface of the coating layer. The amount of the dry air is not especially limited, and it is normally 5 to 20 m/min, and preferably 5 to 15 m/min. By making the amount of the dry air be 5 m/min or more, drying of the coating layer can be prevented from becoming insufficient. On the other hand, because the concentration of an organic solvent (details are described later) in the vicinity of the surface of the coating layer becomes uniform by making the amount of the dry air be 20 m/min or less, its evaporation can be made to be uniform. As a result, the formation of an adhesive layer having a uniform surface state on the surface can be possible.

The drying time is set suitably depending on the coating thickness of the adhesive composition solution, and it is normally in a range of 1 to 5 min, and preferably 2 to 4 min. When the drying time is less than 1 min, the curing reaction does not proceed sufficiently, and the amount of non-reacted curing component and the amount of solvent that remains become large. With this, there maybe a case that problems of outgassing and voids occur in the post process. On the other hand, when the drying time exceeds 5 min, the curing reaction proceeds too much, and as a result, there may be a case that the fluidity and the embedding properties to the adherend decrease.

The drying temperature is not especially limited, and it is normally set in a range of 70 to 160° C. However, in the present invention, the drying is preferably performed by increasing the drying temperature gradually as the drying time passes. Specifically, for example, it is set in a range of 70 to 100° C. in the early stage of drying (from right after drying to 1 min), and it is set in a range of 100 to 160° C. in the later stage of drying (exceeding 1 min to 5 min). With this, generation of pin holes on the surface of the coating layer that occurs when the drying temperature is increased rapidly right after the coating can be prevented. As a result, an adhesive layer can be formed having an uneven surface and having an arithmetic mean roughness Ra of 0.015 to 1 μm.

The bonding step of the pressure-sensitive adhesive layer and the adhesive layer is performed by compression. The bonding temperature is 30 to 50° C., and preferably 35 to 45° C. The bonding pressure is 0.1 to 0.6 MPa, and preferably 0.2 to 0.5 MPa. By bonding the pressure-sensitive adhesive layer and the adhesive layer with these compression conditions, both layers can adhere to each other in a multipoint contact state or an island-like contact state, and the contact area can be made to be in the range of 35 to 90% to the bonding area.

The value of the contact area can be obtained by image analysis in which the image that is obtained by photographing is binarized. An image processor for performing the image analysis is not especially limited as long as it can perform a binarizing process on a photographed gray level image, and any conventionally known processor can be used. Specifically, for example, because similar images are often inspected serially, a threshold value set for a first image (an arbitrary image) is set by an analysis person while watching the screen, and the threshold values of other images are set respectively based on the threshold value that is set in the first image. The binarization of the image signal can be performed using image analysis software on the market. Examples of the software include WinROOF (resistered trademark) manufactured by Mitani Corporation, AdobePhotoshop (resistered trademark) manufactured by Adobe Systems Inc., and NanoHunter NS 2K-Pro (resistered trademark) manufactured by NANO System Corporation.

The releasing film may be peeled after bonding the pressure-sensitive adhesive layer and the adhesive layer or it may be used as a protecting film of the dicing die-bonding film as it is and may be peeled when bonding to a semiconductor wafer, etc. With this, the dicing die-bonding film according to the present embodiment can be manufactured.

Moreover, a method of forming a pressure-sensitive adhesive layer onto the base material (that is, a method of forming a dicing film) is not especially limited, and various conventionally known methods can be adopted. Specifically, they are as follows.

First, the base material can be formed with a conventionally known film forming method. Examples of the film forming method include a calendar film forming method, a casting method in an organic solvent, an inflation extrusion method in a closed system, a T die extrusion method, a coextrusion method, and a dry lamination method.

Next, the pressure-sensitive adhesive layer can be formed by coating a pressure-sensitive adhesive composition solution onto a base material and then drying under prescribed conditions (and heat-crosslinking depending on necessity). The coating method is not especially limited, and examples thereof include roll coating, screen coating, and gravure coating.

The thickness of coating during the coating can be suitably set so that the thickness of the pressure-sensitive adhesive layer that can be finally obtained by drying the coating layer becomes in the range of 1 to 50 μm. Further, the viscosity of the pressure-sensitive adhesive composition solution is not especially limited, and it is preferably 400 to 2500 mPa·s, and more preferably 800 to 2000 mPa·s.

The method of drying of the coating layer is not especially limited, and various conventionally known methods can be adopted. When forming a pressure-sensitive adhesive layer having a smooth surface, drying is preferably performed without using dry air.

The drying time is set suitably depending on the amount of the pressure-sensitive adhesive composition solution to be coated, and it is normally in the range of 0.5 to 5 min, and preferably 2 to 4 min. The drying temperature is not especially limited, and it is normally set in the range of 80 to 150° C., and preferably 80 to 130° C.

According to the above description, a pressure-sensitive adhesive layer can be formed having an arithmetic mean roughness Ra on the bonding surface with the adhesive layer of 0.015 to 0.5 μm.

Moreover, the formation of the pressure-sensitive adhesive layer may be performed by forming a coating film by coating a pressure-sensitive adhesive composition on a separator, and then drying the coating film with the above-described drying conditions. After that, a dicing film can be obtained by transferring the pressure-sensitive adhesive layer onto a base material.

(Dicing Die-Bonding Film)

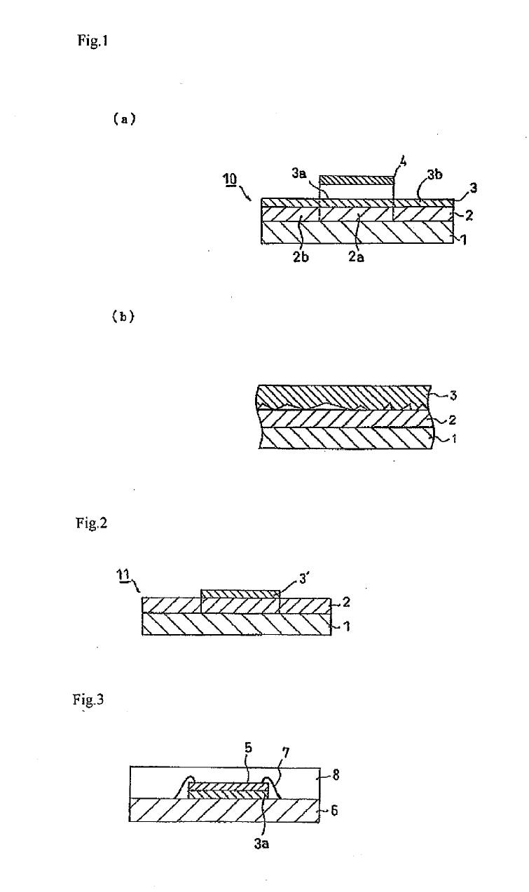

As shown in FIG. 1(a), a dicing die-bonding film 10 has a configuration in which a pressure-sensitive adhesive layer 2 and an adhesive layer 3 are laminated sequentially onto a base material 1. Further, as shown in FIG. 2, it may have a configuration in which an adhesive layer 3′ is formed only on a workpiece bonding portion.

As shown in FIG. 1(b), the pressure-sensitive adhesive layer 2 and the adhesive layer 3 adhere to each other in a multipoint contact state or an island-like contact state. The contact area is in the range of 35 to 90%, preferably 35 to 80%, more preferably 35 to 80%, and especially preferably 35 to 75% to the bonding area. By making the contact area be 35% or more, the peeling properties can be prevented from being excessively large due to a small contact area with the pressure-sensitive adhesive layer, and chip fly of a semiconductor chip during dicing can be prevented from being generated. On the other hand, by making the contact area be 90% or less, the adherability is prevented from becoming excessively large due to a large contact area with the pressure-sensitive adhesive layer, and pickup properties can be prevented from deteriorating.

The arithmetic mean roughness Ra of the adhesive layer 3 on the bonding surface with the pressure-sensitive adhesive layer 2 is 0.015 to 1 μm, and it is preferably 0.05 to 1 μm, and more preferably 0.1 to 1 μm. When the arithmetic mean roughness Ra is 0.015 μm or more, the contact area of the pressure-sensitive adhesive layer 2 and the adhesive layer 3 is suppressed to 90% or less, and an adhesion force canbe prevented from becoming too large. As a result, a decrease of pickup properties of a semiconductor chip during pickup can be reduced. On the other hand, when the arithmetic mean roughness Ra is 1 μm or less, because the contact area of the pressure-sensitive adhesive layer 2 and the adhesive layer 3 can be made to be 35% or more, bonding of the he pressure-sensitive adhesive layer 2 and the adhesive layer 3 is made to be possible, and chip fly of a semiconductor chip during dicing can be prevented from being generated. Further, generation of voids between the adhesive layer 3 and an adherend can be suppressed during die-bonding of a semiconductor chip. As a result, a semiconductor device can be manufactured with prevention of a decrease of reliability.

Moreover, the above-described arithmetic mean roughness is an arithmetic mean roughness defined by JIS surface roughness (B0601). Example of the measuring method of arithmetic mean roughness include a method using a noncontact three-dimensional surface profile measuring apparatus NT8000 manufactured by Veeco Instruments, New View 5032 manufactured by ZYGO Corporation and an atomic force microscope SPM-9500 type manufactured by Shimadzu Corporation.

Next, each configuration member that configures the dicing die-bonding film 10 according to the present embodiment is described in detail.

The base material 1 has radiation transparency and is a strength matrix of the dicing die-bonding films 10, 11. Examples thereof include polyolefin such as low-density polyethylene, straight chain polyethylene, intermediate-density polyethylene, high-density polyethylene, very low-density polyethylene, random copolymer polypropylene, block copolymer polypropylene, homopolypropylene, polybutene, and polymethylpentene; an ethylene-vinylacetate copolymer; an ionomer resin; an ethylene(meth)acrylic acid copolymer; an ethylene(meth)acrylic acid ester (random or alternating) copolymer; an ethylene-butene copolymer; an ethylene-hexene copolymer; polyurethane; polyester such as polyethyleneterephthalate and polyethylenenaphthalate; polycarbonate; polyetheretherketone; polyimide; polyetherimide; polyamide; whole aromatic polyamides; polyphenylsulfide; aramid (paper); glass; glass cloth; a fluorine resin; polyvinyl chloride; polyvinylidene chloride; a cellulose resin; a silicone resin; metal (foil); and paper.

Further, the material of the base material 1 includes a polymer such as a cross-linked body of the above resins. The above plastic film may be also used unstreched, or may be also used on which a monoaxial or a biaxial stretching treatment is performed depending on necessity. According to resin sheets in which heat shrinkable properties are given by the stretching treatment, etc., the adhesive area of the pressure sensitive adhesive layer 2 and the adhesive layers 3, 3′ is reduced by thermally shrinking the base material 1 after dicing, and the recovery of the semiconductor chips can be facilitated.

A known surface treatment such as a chemical or physical treatment such as a chromate treatment, ozone exposure, flame exposure, high voltage electric exposure, and an ionized radiation treatment, and a coating treatment by an undercoating agent (for example, a tacky substance described later) can be performed on the surface of the base material 1 in order to improve adhesiveness, holding properties, etc. with the adjacent layer.

The same type or different type of base material can be appropriately selected and used as the base material 1, and a base material in which a plurality of types are blended can be used depending on necessity. Further, a vapor-deposited layer of a conductive substance composed of a metal, an alloy, an oxide thereof, etc. and having a thickness of about 30 to 500 angstrom can be provided on the base material 1 in order to give an antistatic function to the base material 1. The base material 1 may be a single layer or a multi layer of two or more types.

The thickness of the base material 1 can be appropriately decided without limitation particularly. However, it is generally about 5 to 200 μm.

The pressure sensitive adhesive layer 2 is constituted by containing a radiation curable pressure sensitive adhesive. The radiation curable pressure sensitive adhesive can easily decrease its adhesive strength by increasing the degree of crosslinking by irradiation with radiation. By radiating only a part 2a corresponding to the semiconductor wafer pasting part of the pressure sensitive adhesive layer 2 shown in FIG. 2, a difference of the adhesive strength to another part 2b can be also provided. Here, the radiation includes ultraviolet ray, electron beam, etc.

Further, by curing the radiation curable pressure sensitive adhesive layer 2 with the adhesive layer 3′ shown in FIG. 2, the part 2a in which the adhesive strength is remarkably decreased can be formed easily. Because the adhesive layer 3′ is pasted to the part 2a in which the adhesive strength is decreased by curing, the interface of the part 2a of the pressure sensitive adhesive layer 2 and the adhesive layer 3′ has a characteristic of being easily peeled during pickup. On the other hand, the part not radiated by ultraviolet rays has sufficient adhesive strength, and forms the part 2b.

As described above, in the pressure sensitive adhesive layer 2 of the dicing die-bonding film 10 shown in FIG. 1, the part 2b formed by a non-cured radiation curable pressure sensitive adhesive sticks to the adhesive layer 3, and the holding force when dicing can be secured. In such a way, the radiation curable pressure sensitive adhesive can support the adhesive layer 3 for fixing the semiconductor chip onto an adherend such as a substrate with good balance of adhesion and peeling. In the pressure sensitive adhesive layer 2 of the dicing die-bonding film 11 shown in FIG. 2, a dicing ring is fixed to the part 2b. The dicing ring made of a metal such as stainless steel or a resin can be used for example.

An ultraviolet-ray curing-type pressure-sensitive adhesive having an ultraviolet-ray curing-type functional group such as a carbon-carbon double bond and having adherability can be used without special limitation. Example of the ultraviolet-ray curing-type pressure-sensitive adhesive include an additive-type ultraviolet-ray curing-type pressure-sensitive adhesives in which an ultraviolet-ray curing-type monomer component or oligomer component is mixed into a general pressure-sensitive adhesive such as an acrylic pressure-sensitive adhesive or a rubber-based pressure-sensitive adhesive.

An acrylic pressure-sensitive adhesive having an acrylic polymer as a base polymer is preferable as the pressure-sensitive adhesive from the point of view of clean washing properties of an electric part such as a semiconductor wafer and glass that dislike contamination with ultra pure water and an organic solvent such as alcohol.

Examples of the acrylic polymer include acrylic polymers each comprising, as one or more monomer components, one or more selected from alkyl esters of (meth)acrylic acid (for example, linear and branched alkyl esters thereof each having an alkyl group having 1 to 30 carbon atoms, in particular, 4 to 18 carbon atoms, such as methyl ester, ethyl ester, propyl ester, isopropyl ester, butyl ester, isobutyl ester, s-butyl ester, t-butyl ester, pentyl ester, isopentyl ester, hexyl ester, heptyl ester, octyl ester, 2-ethylhexyl ester, isooctyl ester, nonyl ester, decyl ester, isodecyl ester, undecyl ester, dodecyl ester, tridecyl ester, tetradecyl ester, hexadecyl ester, octadecyl ester, and eicosyl ester thereof) and cycloalkyl esters of (meth)acrylic acid (for example, cyclopentyl ester and cyclohexyl ester thereof). The wording “esters of (meth)acrylic acid” means esters of acrylic acid and/or methacrylic acid. All of the words including “(meth)” in connection with the present invention have an equivalent meaning.

The acrylic polymer may optionally contain a unit corresponding to a different monomer component copolymerizable with the above-mentioned alkyl ester of (meth)acrylic acid or cycloalkyl ester thereof in order to improve the cohesive force, heat resistance or some other property of the polymer. Examples of such a monomer component include carboxyl-containing monomers such as acrylic acid, methacrylic acid, carboxyethyl(meth)acrylate, carboxypentyl(meth)acrylate, itaconic acid, maleic acid, fumaric acid, and crotonic acid; acid anhydride monomers such as maleic anhydride, and itaconic anhydride; hydroxyl-containing monomers such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxylmethylcyclohexyl)methyl(meth)acrylate; sulfonic acid group containing monomers such as styrenesulfonic acid, allylsulfonic acid, 2-(meth)acrylamide-2-methylpropanesulfonic acid, (meth)acrylamide propanesulfonic acid, sulfopropyl(meth)acrylate, and (meth)acryloyloxynaphthalene sulfonic acid; phosphoric acid group containing monomers such as 2-hydroxyethylacryloyl phosphate; acrylamide; and acrylonitrile. These copolymerizable monomer components may be used alone or in combination of two or more thereof. The amount of the copolymerizable monomer(s) to be used is preferably 40% or less by weight of all the monomer components.

For crosslinking, the acrylic polymer can also contain multifunctional monomers if necessary as the copolymerizable monomer component. Such multifunctional monomers include hexane diol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, epoxy(meth)acrylate, polyester(meth)acrylate, urethane(meth)acrylate etc. These multifunctional monomers can also be used as a mixture of one or more thereof. From the viewpoint of adhesiveness etc., the use amount of the multifunctional monomer is preferably 30 wt % or less based on the whole monomer components.

The acrylic polymer can be obtained by polymerizing a single monomer or a mixture of monomers of two types or more. The polymerization can be performed with any of polymerization methods such as solution polymerization, emulsification polymerization, bulk polymerization, and suspension polymerization. The content of a low molecular weight material is preferably small from the point of view of prevention of contamination to a clean adherend. In this respect, the number average molecular weight of the acrylic polymer is preferably about 300,000 or more, and more preferably about 400,000 to 3,000,000.

Further, an external crosslinking agent can be suitably adopted to the pressure-sensitive adhesive in order to increase the number average molecular weight of an acrylic polymer that is a base polymer, etc. Specific examples of the external crosslinking method include methods of reacting by adding a so-called crosslinking agents such as a polyisocyanate compound, an epoxy compound, an aziridine compound, and a melamine based crosslinking agent. When the external crosslinking agent is used, the amount to be used can be suitably determined by the balance with the base polymer that is to be crosslinked and by the purpose of use as a pressure-sensitive adhesive. In general, it is preferably mixed at about 5 parts by weight or less, and more preferably 0.1 to 5 parts by weight to 100 parts by weight of the base polymer. Besides the above-described components, an additive such as conventionally known various tackifiers and antioxidants may be used in the pressure-sensitive adhesive depending on necessity.

The radiation-curing monomer component to be compounded includes, for example, urethane oligomer, urethane(meth)acrylate, trimethylol propane tri(meth)acrylate, tetramethylol methane tetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, 1,4-butane diol di(meth)acrylate, tetraethylene glycol di(meth)acrylate, 1,6-hexane diol(meth)acrylate, neopentyl glycol di(meth)acrylate etc.; ester acrylate oligomers; and isocyanurates or isocyanurate compounds such as 2-propenyl-3-butenyl cyanurate, tris(2-methacryloxyethyl)isocyanurate etc. The radiation-curing oligomer component includes various acrylate oligomers such as those based on urethane, polyether, polyester, polycarbonate, polybutadiene etc., and their molecular weight is preferably in the range of about 100 to 30000. For the compounded amount of the radiation-curable monomer component or oligomer component, the amount of which the adhesive strength of the pressure-sensitive adhesive layer can be decreased can be determined appropriately depending on the type of the above-described pressure-sensitive adhesive layer. In general, the compounded amount is, for example, 5 to 500 parts by weight relative to 100 parts by weight of the base polymer such as an acrylic polymer constituting the pressure-sensitive adhesive, and preferably about 40 to 150 parts by weight.

Besides the additive-type ultraviolet-ray curing-type pressure-sensitive adhesive that is explained above, examples of the ultraviolet-ray curing-type pressure-sensitive adhesive include an internal ultraviolet-ray curing-type pressure-sensitive adhesive in which a polymer having a carbon-carbon double bond in the polymer side chain, in the main chain, or in the ends of the main chain is used as the base polymer. The internal ultraviolet-ray curing-type pressure-sensitive adhesive does not have to contain an oligomer component that is a low molecular weight component, etc., or it does not contain much of the component. Therefore, it is preferable because a pressure-sensitive adhesive layer having a stable layer structure can be formed without the oligomer component, etc. shifting in the pressure-sensitive adhesive with the passage of time.

A base polymer having a carbon-carbon double bond and having adherability can be used without limitation. As such base polymer, a polymer having an acrylic polymer as a basic skeleton is preferable. Examples of the basic skeleton of the acrylic polymer include the acrylic polymers shown above.

A method of introducing a carbon-carbon double bond into the acrylic polymer is not especially limited, and various methods can be adopted. However, a molecular design is easy when the carbon-carbon double bond is introduced in the polymer side chain. For example, a method of copolymerizing a monomer having a functional group with an acrylic polymer and then performing condensation or an addition reaction on a compound having a functional group that can react with the functional group of the monomer and having a carbon-carbon double bond while maintaining the ultra-violet curing property of a carbon-carbon double bond.

Examples of the combination of these functional groups include a carboxylic acid group and an epoxy group, a carboxylic acid group and an aziridyl group, and a hydroxyl group and an isocyanate group. Among these combinations of the functional group, the combination of a hydroxyl group and an isocyanate group is preferable because of ease of pursuing the reaction. Further, the functional group may be in any side of the acrylic polymer and the above-describe compounds as long as it is a combination of these functional groups so that the acrylic polymer having a carbon-carbon double bond is produced. However, the case where the acrylic polymer has a hydroxyl group and the above-described compound has an isocyanate group is preferable in the above-described preferable combination. In this case, examples of the isocyanate compound having a carbon-carbon double bond include methacryloylisocyanate, 2-methacryloyloxyethylisocyanate, and m-isopropenyl-α,α-dimethylbenzylisocyanate. Further, a polymer in which the hydroxyl group containing the monomers exemplified above and an ether based compound of 2-hydroxyethylvinylether, 4-hydroxybutylvinylether, diethylene glycol monovinylether, etc. are copolymerized can be used as the acrylic polymer.

A base polymer having a carbon-carbon double bond (especially, acrylic polymer) can be used alone as the internal-type ultraviolet-ray curing type pressure-sensitive adhesive. However, the above-described ultraviolet-ray curing-type monomer component or oligomer component can be mixed to an extent that its characteristics do not deteriorate. The amount of the ultraviolet-ray curing-type oligomer component, etc. is normally in the range of 0 to 30 parts by weight and preferably in the range of 0 to 10 parts by weight to 100 parts by weight of the base polymer.

A photopolymerization initiator is contained in the internal radiation curable pressure sensitive adhesive in the case of curing with radiation such as ultraviolet rays. Examples of the photopolymerization initiator include an α-ketol based compound such as 4-(2-hydroxyethoxy)phenyl(2-hydroxy-2-propyl)ketone, α-hydroxy-α,α′-dimethylacetophenone, 2-methyl-2-hydroxypropyophenone, and 1-hydroxycyclohexylphenylketone; an acetophenone based compound such as methoxyacetophenone, 2,2-dimethoxy-2-phenylcetophenone, 2,2-diethoxyacetophenone, and 2-methyl-1-[4-(methylthio)-phenyl]-2-morpholinopropane-1; a benzoinether based compound such as benzoinethylether, benzoinisopropylether, and anisoinmethylether; a ketal based compound such as benzyldimethylketal; an aromatic sulfonylchloride based compound such as 2-naphthalenesulfonylchloride; a photoactive oxime based compound such as 1-phenone-1,1-propanedion-2-(o-ethoxycarbonyl)oxime; a benzophenone based compound such as benzophenone, benzoylbenzoic acid and 3,3′-dimethyl-4-methoxybenzophenone; a thioxanthone based compound such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, and 2,4-diisopropylthioxanthone; camphorquinone; halogenated ketone; acylphosphinoxide; acylphosphonate and the like. The compounding amount of the photopolymerization initiator is about 0.05 to 20 parts by weight for example based on 100 parts by weight of the base polymer such as an acryl polymer constituting the pressure sensitive adhesive.

Further, examples of the radiation curable pressure sensitive adhesive include a rubber based pressure sensitive adhesive and acryl-based pressure sensitive adhesive containing an addition polyerizable compound having two or more unsaturated bonds, aphotopolymerizable compound such as alkoxysilane having an epoxy group, and a photopolymerization initiator such as a carbonyl compound, an organic sulfur compound, a peroxide, an amine salt-based and an onium salt based compound, which are disclosed in JP-A No. 60-196956.

The adhesive power of the pressure-sensitive adhesive layer 2 is preferably 0.04 to 0.2 N/10 mm width and more preferably 0.06 to 0.1 N/10 mm width (90 degree peel releasing force, peeling rate 300 mm/mm) to the adhesive layers 3, 3′. If it is within the above-described value range, when picking up the semiconductor chip with the adhesive of the die-bonding film, better pickup properties can be expected without fixing the semiconductor chip more than necessary.

The method of forming the part 2a in the pressure sensitive adhesive layer 2 includes a method of forming the radiation curable pressure sensitive adhesive layer 2 on the base material 1 and then radiating the part 2a with radiation partially and curing. The partial radiation irradiation can be performed through a photo mask in which a pattern is formed which is corresponding to a part 3b, etc. other than the semiconductor wafer pasting part 3a. Further, examples include a method of radiating in a spot manner and curing, etc. The formation of the radiation curable pressure sensitive adhesive layer 2 can be performed by transferring the pressure sensitive adhesive layer provided on a separator onto the base material 1. The partial radiation curing can be also performed on the radiation curable pressure sensitive adhesive layer 2 provided on the separator.

In the pressure sensitive adhesive layer 2 of the dicing die-bonding film 10, the radiation irradiation may be performed on a part of the pressure sensitive adhesive layer 2 so that the adhesive strength of the part 2a becomes smaller than the adhesive strength of other parts 2b. That is, the part 2a in which the adhesive strength is decreased can be formed by using those in which the entire or a portion of the part other than the part corresponding to the semiconductor wafer pasting part 3a on at least one face of the base material 1 is shaded, forming the radiation curable pressure sensitive adhesive layer 2 onto this, then radiating radiation, and curing the part corresponding the semiconductor wafer pasting part 3a. The shading material that can be a photo mask on a supporting film can be manufactured by printing, vapor deposition, etc. Accordingly, the dicing die-bonding film 10 of the present invention can be produced with efficiency.

The thickness of the pressure sensitive adhesive layer 2 is not particularly limited. However, it is preferably about 1 to 50 μm from the viewpoints of compatibility of chipping prevention of the chip cut face and holding the fixation of the adhesive layer, etc. It is preferably 2 to 30 μm, and further preferably 5 to 25 μm.

The above-described adhesive layer is a layer having an adhesion function, and its constituting materials include a material using a thermoplastic resin and a thermosetting resin together. Further, a thermoplastic resin can be used alone.

The lamination structure of the adhesive layers 3, 3′ is not especially limited, and examples include a structure consisting of a single layer of the adhesive layer and a multilayer structure in which an adhesive layer is formed on one side or both sides of a core material. Examples of the core material are a film such as a polyimide film, a polyester film, a polyethylene terephthalate film, a polyethylene naphthalate film, and a polycarbonate film, a resin substrate that is reinforced with a glass fiber or a plastic non-woven resin, a silicon substrate, and a glass substrate.

Examples of the thermoplastic resin include a natural rubber, a butyl rubber, an isoprene rubber, a chloroprene rubber, an ethylene-vinylacetate copolymer, an ethylene-acrylic acid copolymer, an ethylene-acrylate copolymer, a polybutadiene resin, a polycarbonate resin, a thermoplastic polyimide resin, a polyamide resin such as 6-nylon and 6,6-nylon, a phenoxy resin, an acrylic resin, a saturated polyester resin such as PET and PBT, a polyamideimide resin, and a fluorine resin. These thermoplastic resins can be used alone or two type or more can be used in combination. Among these thermoplastic resins, the acrylic resin is particularly preferable in which the ionic impurities are less, the heat resistance is high, and reliability of the semiconductor element can be secured.

The acrylic resin is not particularly limited, and examples include such as polymers having one type or two types or more of acrylic acid or methacrylic ester having a straight chain or branched alkyl group having 30 or more carbon atoms, particularly 4 to 18 carbon atoms as a component. Examples of the alkyl group include a methyl group, an ethyl group, a propyl group, an isopropyl group, an n-butyl group, a t-butyl group, an isobutyl group, an amyl group, an isoamyl group, a hexyl group, a heptyl group, a cyclohexyl group, a 2-ethylhexyl group, an octyl group, an isooctyl group, a nonyl group, an isononyl group, a decyl group, an isodecyl group, an undecyl group, a lauryl group, a tridecyl group, a tetradecyl group, a stearyl group, an octadecyl group, and a dodecyl group.

Further, other monomers forming the polymers are not particularly limited, and examples include a carboxyl group-containing monomer such as acrylic acid, methacrylic acid, carboxylethylacrylate, carboxylpentylacrylate, itaconic acid, maleic acid, fumaric acid, and chrotonic acid; an acid anhydride monomer such as maleic anhydride and itaconic anhydride; a hydroxyl group-containing monomer such as 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate, and (4-hydroxymethylcyclohexyl)-methylacrylate; a sulfonic acid-containing monomer such as styrenesulfonic acid, allylsulfonic acid, 2-(meth)acrylamide-2-methylpropanesulfonic acid, (meth)acrylamidepropane sulfonic acid, sulfopropyl(meth)acrylate, and (meth)acryloyloxynaphthalene sulfonic acid; and a phosphoric acid-containing monomer such as 2-hydroxyethylacryloylphosphate.

Further, other thermosetting resins or thermoplastic resins can be used together in the adhesive layer 3 depending on necessity. Examples of the thermosetting resin include such as a phenol resin, an amino resin, an unsaturated polyester resin, a polyurethane resin, a silicone resin, and a thermosetting polyimide resin. These resins can be used alone or two or more types can be used in combination. Further, the curing agent of the epoxy resin is preferably a phenol resin.

The adhesive layer 3 according to the present invention is constituted by containing an epoxy resin as a main component. The epoxy resin is preferable from the viewpoint of containing fewer ionic impurities, etc. that corrode a semiconductor element. The epoxy resin is not particularly limited as long as it is generally used as an adhesive composition, and for example, a difunctional epoxy resin and a polyfunctional epoxy resin of such as a bispehnol A type, a bisphenol F type, a bisphenol S type, a brominated bisphenol A type, a hydrogenated bisphenol A type, a bisphenol AF type, a biphenyl type, a naphthalene type, a fluorine type, a phenol novolak type, an ortho-cresol novolak type, a trishydroxyphenylmethane type, and a tetraphenylolethane type epoxy resin or an epoxy resin of such as a hydantoin type, a trisglycidylisocyanurate type and a glycidylamine type epoxy resin are used. These can be used alone or two or more types can be used in combination. Among these epoxy resins, a novolak type epoxy resin, a biphenyl type epoxy resin, a trishydroxyphenylmethane type resin, and a tetraphenylolethane type epoxy resin are particularly preferable. This is because these epoxy resins have high reactivity with a phenol resin as a curing agent, and are superior in heat resistance, etc,

Further, other thermosetting resins or thermoplastic resins can be used together in the adhesive layer 3 depending on necessity. Examples of the thermosetting resin include such as a phenol resin, an amino resin, an unsaturated polyester resin, a polyurethane resin, a silicone resin, and a thermosetting polyimide resin. These resins can be used alone or two or more types can be used in combination. Further, the curing agent of the epoxy resin is preferably a phenol resin.

The compounding ratio of the epoxy resin and the phenol resin is preferably made, for example, such that the hydroxy group in the phenol resin becomes 0.5 to 2.0 equivalent per equivalent of epoxy group in the epoxy resin component. It is more preferably 0.8 to 1.2 equivalent. That is, when the both compounding ratio becomes outside of the range, a sufficient curing reaction does not proceed, and the characteristics of the epoxy resin cured product easily deteriorate.

In the present invention, die-bonding film comprising the epoxy resin, the phenol resin, and an acrylic resin is particularly preferable. Since these resins contain ionic impurities in only a small amount and have high heat resistance, the reliability of the semiconductor element can be ensured. About the blend ratio in this case, the amount of the mixture of the epoxy resin and the phenol resin is from 10 to 200 parts by weight for 100 parts by weight of the acrylic resin component.

In order to crosslink the adhesive layers 3, 3′ of the present invention to some extent in advance, it is preferable to add, as a crosslinking agent, a polyfunctional compound which reacts with functional groups of molecular chain terminals of the above-mentioned polymer to the materials used when the sheet 12 is produced. In this way, the adhesive property of the sheet at high temperatures is improved so as to improve the heat resistance.

The crosslinking agent may be one known in the prior art. Particularly preferable are polyisocyanate compounds, such as tolylene diisocyanate, diphenylmethane diisocyanate, p-phenylene diisocyanate, 1,5-naphthalene diisocyanate, and adducts of polyhydric alcohol and diisocyanate. The amount of the crosslinking agent to be added is preferably set to 0.05 to 7 parts by weight for 100 parts by weight of the above-mentioned polymer. If the amount of the crosslinking agent to be added is more than 7 parts by weight, the adhesive force is unfavorably lowered. On the other hand, if the adding amount is less than 0.05 part by weight, the cohesive force is unfavorably insufficient. A different polyfunctional compound, such as an epoxy resin, together with the polyisocyanate compound may be incorporated if necessary.

An inorganic filler maybe appropriately incorporated into the die-bonding film of the present invention in accordance with the use purpose thereof. The incorporation of the inorganic filler makes it possible to confer electric conductance to the sheet, improve the thermal conductivity thereof, and adjust the elasticity.

Examples of the inorganic fillers include various inorganic powders made of the following: a ceramic such as silica, clay, plaster, calcium carbonate, barium sulfate, aluminum oxide, beryllium oxide, silicon carbide or silicon nitride; a metal such as aluminum, copper, silver, gold, nickel, chromium, lead, tin, zinc, palladium or solder, or an alloy thereof; and carbon. These may be used alone or in combination of two or more thereof. Among these, silica, in particular fused silica is preferably used.

The average particle size of the inorganic filler is preferably in the range of 0.1 to 5 μm, and more preferably in the range of 0.2 to 3 μm. When the average particle size of the inorganic filler is less than 0.1 μm, it becomes difficult to make the Ra of the adhesive layer be 0.15 μm or more. On the other hand, when the average particle size exceeds 5 μm, it becomes difficult to make Ra be less than 1 μm. Moreover, inorganic fillers having a different average particle size may be combined and used in the present invention. Further, the average particle size is a value that is obtained with an optical particle size distribution meter (manufactured by HORIBA, Ltd., name of apparatus: LA-910) for example.

The mixing amount of the inorganic filler is preferably set to 20 to 80 parts by weight to 100 parts by weight of the organic resin component. It is especially preferably 20 to 70 parts by weight. When the mixing amount of the inorganic filler is less than 20 parts by weight, the heat resistance decreases, and therefore the adhesive layers 3, 3′ are cured when being exposed to a thermal history of a high temperature for a long time, and there is a case where fluidity and embedding properties decrease. Further, when it exceeds 80% parts by weight, the storage elastic modulus of the adhesive layers 3, 3′ becomes large. Because of this, stress relaxation of the cured adhesive becomes difficult, and there is a case where the embedding properties of the uneven surface decrease in the sealing step.

If necessary, other additives besides the inorganic filler may be incorporated into the adhesive layers 3, 3′ of the present invention. Examples thereof include a flame retardant, a silane coupling agent, and an ion trapping agent.

Examples of the flame retardant include antimony trioxide, antimony pentaoxide, and brominated epoxy resin. These maybe used alone or in combination of two or more thereof.

Examples of the silane coupling agent include β-(3,4-epoxycyclohexyl)ethyltrimethoxysilane, γ-glycidoxypropyltrimethoxysilane, and γ-glycidoxypropylmethyldiethoxysilane. These may be used alone or in combination of two or more thereof.

Examples of the ion trapping agent include hydrotalcite and bismuth hydroxide. These may be used alone or in combination of two or more thereof.

The thickness of the die-bonding film (in the case that the film is a laminate, the total thickness thereof) is not particularly limited, and is, for example, from about 5 to 100 μm, preferably from about 5 to 50 μm.

The adhesive layers 3, 3′ of the dicing die-bonding film 10, 11 is preferably protected by a separator (not shown in the drawings). The separator has a function as a protective material to protect the adhesive layers 3, 3′ until the film is put to practical use. Further, the separator can be used also as a support base when the adhesive layers 3, 3′ is transferred to the pressure-sensitive adhesive layer 2. The separator is peeled off when the workpiece is pasted onto the adhesive layers 3, 3′ of the dicing die-bonding film. Polyethylene terephthalate (PET), polyethylene, polyprolylene, a plastic film whose surface is coated with a peeling agent such as a fluorine peeling agent or a long-chain alkylacrylate peeling agent, paper, and the like can also be used as the separator.

The adhesive layers 3, 3′ preferably have elasticity of some level at least in the direction perpendicular to the in-plane direction in the aspect of its adhesive function. On the other hand, in the case where the adhesive layers 3, 3′ have excessive elasticity as a whole, the elastic force of the adhesive layers 3, 3′ hinders keeping the lead frame in which the adhesive layers 3, 3′ are pasted sufficiently fixed even when attempting to connect the bonding wire during wire bonding. As a result, compression energy due to the applied pressure is relaxed, and a bonding failure is generated. The wire bonding step is performed under a high temperature condition of about 150° C. to 200° C. Because of that, the tensile storage elastic modulus of the adhesive layers 3, 3′ at 120° C. before curing is preferably 1×10⁴ Pa or more, and more preferably 0.1 to 20 Pa. When the tensile storage elastic modulus is less than 1×10⁴ Pa, the adhesive layers 3, 3′ that melt during dicing stick to the semiconductor chip for example, and there is a case where the pickup becomes difficult. Further, the tensile storage elastic modulus of the adhesive layers 3, 3′ at 200° C. after curing is preferably 50 MPa or less, and more preferably 0.5 MPa to 40 MPa. When it exceeds 50 MPa, there is a case where the embedding properties of the adhesive layers 3, 3′ of the uneven surface decrease when molding after the wire bonding. Moreover, by making the tensile storage elastic modulus be 0.5 MPa or more, a stable connection becomes possible in a semiconductor device that is characterized by a leadless structure. The tensile storage elastic modulus can be adjusted by suitably adjusting the added amount of the inorganic filler.

As a method of measuring the tensile storage elastic modulus, only the adhesive layers 3, 3′ are obtained by coating on a peeling liner on which a releasing treatment is carried out so that the thickness becomes 100 μm. The adhesive layers 3, 3′ are left in an oven at 150° C. for 1 hr, and then the tensile storage elastic modulus of the adhesive layers 3, 3′ at 200° C. is measured using a viscoelasticity measuring apparatus (manufactured by TA Instrument Japan: type: RSA-II). In more detail, the samples size is made to be length 30.0 mm×width 5.0 mm×thickness 0.1 mm, the measurement sample is set in a jig for film tensile measurement, and the measurement is performed under a condition of a temperature range of 50 to 250° C., a frequency of 1.0 Hz, a distortion of 0.025%, and a temperature rising rate of 10° C./min.

(Method of Manufacturing Semiconductor Device)

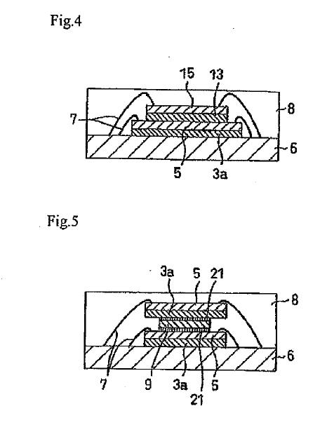

The separator that is optionally provided onto the adhesive layers 3, 3′ is appropriately peeled off, and the dicing die-bonding film 10, 11 of the present invention is used as follows. The manufacturing method is explained below referring to FIG. 3 using the case of the dicing die-bonding film 11 as an example.

First, a semiconductor wafer 4 is fixed onto the adhesive layers 3, 3′ in the dicing die-bonding films 10, 12 by press-bonding and by adhering and holding (mounting step). The present step is performed while pressing with a pressing means such as a press-bonding roll.

Next, dicing of the semiconductor wafer 4 is performed. With this operation, a semiconductor chip 5 is formed by cutting the semiconductor wafer 4 into a prescribed size to make it into individual pieces. The dicing is performed following an ordinary method from the circuit face side of the semiconductor wafer 4, for example. Further, a cutting method, so-called full cut, in which cutting-in is performed to the dicing die-bonding film 10, can be adopted in the present step, for example. The dicing apparatus that is used in the present step is not especially limited, and a conventionally known apparatus can be used. Further, because the semiconductor wafer is adhered and fixed by the dicing die-bonding film 10, chip breakage and chip fly can be suppressed, and at the same time, damage of the semiconductor wafer 4 can be suppressed.

Picking up of the semiconductor chip 5 is performed to peel off the semiconductor chip that is adhered and fixed to the dicing die-bonding film 10. The method of picking up is not especially limited, and various conventionally known methods can be adopted. Examples thereof include a method of pushing up an individual semiconductor chip 5 from the dicing die-bonding film 10 side using a needle and picking up the semiconductor chip 5 that is pushed up with a picking up apparatus.

Here, the pickup can be performed after irradiating the pressure-sensitive adhesive layer 2 with the ultraviolet ray because the pressure-sensitive adhesive layer 2 is of an ultraviolet-ray curing-type. With this operation, the adhesive strength of the pressure-sensitive adhesive layer 2 to the die-bonding film 3a decreases, and the semiconductor chip 5 is easily peeled off. As a result, the pickup becomes possible without damaging the semiconductor chip. The conditions during ultraviolet ray irradiation such as the radiation strength and the radiation time are not especially limited, and may be appropriately set as necessary. For example, the cumulative radiation of the ultraviolet ray is preferably 50 to 500 mJ/cm². Even in the above-described range of the cumulative radiation, peeling of the die-bonding film of the present invention does not become difficult due to excessive crosslinking by the ultraviolet ray irradiation, and the die-bonding film of the present invention exhibits a good pickup property. Further, the above-described one can be used for the ultraviolet ray irradiation.

The semiconductor chip 5 that is picked up is adhered and fixed to an adherend 6 interposing the die-bonding film 3a therebetween (die-bonding). The adherend 6 is loaded on a heat block 9. Examples of the adherend 6 include a lead frame, a TAB film, a substrate, and a semiconductor chip that is separately produced. The adherend 6 may be a deformable adherend that can be deformed easily or may be a non-deformable adherend such as a semiconductor wafer that is difficult to be deformed.

As the substrate, a conventionally known one can be used. Further, metal lead frames such as a Cu lead frame and a 42 Alloy lead frame and an organic substrate made of glass epoxy, BT (Bismaleimide-Triazine), polyimide, and the like can be used as the lead frame. However, the present invention is not limited to the above-described ones, and a circuit substrate is also included in which a semiconductor element is mounted and that can be used by being electrically connected with the semiconductor element.

When the adhesive layer 3 is of a thermosetting type, the heat resistant strength is improved by adhering and fixing the semiconductor chip 5 to the adherend 6 by heat-curing. The substrate or the like to which the semiconductor chip 5 is adhered and fixed interposing the semiconductor wafer pasting portion 3a therebetween can be subjected to a reflow step.

The die-bonding may be simply temporarily fixed onto an adherend 6 without curing the adhesive layer 3. After that, wire bonding can be performed without going through a heating step, the semiconductor chip can be sealed with a sealing resin, and the sealing resin can be after-cured.

In this case, the adhesive layer 3 is preferably used having a shear adhering strength when temporarily fixing of 0.2 MPa or more, and more preferably in the range of 0.2 to 10 MPa to the adherend 6. When the shear adhering strength of the adhesive layer 3 is at least 0.2 MPa or more, shear deformation does not occur in the adhesion surface of the adhesive layer 3 with a semiconductor chip 5 or the adherend 6 due to ultrasonic vibration and heating in the successive step even when the wire bonding step is performed without going through the heating step. That is, a semiconductor device does not move due to the ultrasonic vibration during wire bonding, and with this, a decrease of success rate of the wire bonding is prevented.

The wire bonding is a step of electrically connecting the tip of a terminal portion (inner lead) of the adherend 6 and an electrode pad (not shown in the figures) on the semiconductor chip with a bonding wire 7 (refers to FIG. 3). Examples of the bonding wire 7 that can be used include a gold wire, an aluminum wire, and a copper wire. The temperature when performing the wire bonding is in the range of 80 to 250° C. and preferably in the range of 80 to 220° C. The heating time is a few seconds to a few minutes. The connection is in a heated state so that the temperature becomes in the above-described range, and it is performed using both the vibration energy due to ultrasonic waves and the compression energy due to the applied pressure.

The present step can be performed without fixing by an adhesive layer 3a. The fixing of the semiconductor chip 5 and the adherend 6 by the adhesive layer 3a does not occur in the process of the present step.

The sealing step is a step of sealing the semiconductor chip with a sealing resin 8 (refers to FIG. 3). The present step is performed to protect the semiconductor chip 5 and the bonding wire 7 that are mounted on the adherend 6. The present step is performed by molding a resin for sealing with a mold. Example of the sealing resin 8 that is used include epoxy resins. The resin sealing is performed normally at a heating temperature of 175° C. for 60 to 90 seconds. However, the present invention is not limited to this and it can be performed by curing at 165 to 185° C. for a few minutes for example. With this, the sealing resin is cured and the semiconductor chip 5 and the adherend 6 are fixed with the adhesive layer 3a in between. That is, in the present invention, fixing by the adhesive layer 3a is possible in the present step even when the post curing step that is described later is not performed, and the present invention can contribute to a reduction of the number of manufacturing steps and a shortening of the manufacturing time of a semiconductor device.

In the post curing step, the sealing resin 8 that is not sufficiently cured in the sealing step is cured completely. Even when the fixing does not occur by the adhesive layer 3a in the sealing step, the curing of the sealing resin 8 and the fixing by the adhesive layer 3a become possible in the present step. The heating temperature in the present step differs depending on the type of the sealing resin. However, it is in the range of 165 to 185° C. for example, and the heating time is about 0.5 to 8 hours.

Further, the dicing die-bonding film of the present invention can be preferably used even when a plurality of semiconductor chips are laminated and three-dimensionally mounted as shown in FIG. 4. FIG. 4 is a cross-sectional schematic drawing showing an example of three-dimensionally mounting a semiconductor chip with an adhesive layer. In the case of the three-dimensional mounting shown in FIG. 4, first, at least one of the adhesive layers 3a that are cut out so as to have the same size as the semiconductor chip is temporarily fixed onto the adherend 6, and then the semiconductor chip 5 is temporarily fixed with the adhesive layer 3a between so that its wire bonding surface is the top side. Next, a die-bonding film 13 is temporarily fixed while avoiding the electrode pad portion of the semiconductor chip 5. Further, another semiconductor chip 15 is temporarily fixed onto the die-bonding film 13 so that its wire bonding surface is the top side.

Next, the wire bonding step is performed without performing the heating step. With this, each of the electrode pads in the semiconductor chip 5 and the other semiconductor chip 15 and the adherend 6 are electrically connected by the bonding wire 7.

Next, the sealing step is performed to seal the semiconductor chip 5, etc. with the sealing resin 8, and the sealing resin is cured. At the same time, the adherend 6 and the semiconductor chip 5 are fixed by the adhesive layer 3a. Further, the semiconductor chip 5 and the other semiconductor chip 15 are also fixed by the die-bonding film 13. Moreover, the post curing step may be performed after the sealing step.

Also in the case of the three-dimensional mounting of the semiconductor chip, simplification of the manufacturing process and improvement of the yield can be attempted because the heat treatment by heating the adhesive layer 3a, 13. Further, it becomes possible to make a semiconductor device even thinner because there is no warping of the adherend 6, and no generation of cracks in the semiconductor chip 5 and the other semiconductor chip 15 occurs.

It may be three-dimensional mounting in which a spacer is laminated between the semiconductor chips with the die-bonding film between as shown in FIG. 5. FIG. 5 is a cross-sectional schematic drawing showing an example of three-dimensionally mounting two semiconductor chips with a spacer using the adhesive layer.

In the case of three-dimensional mounting shown in FIG. 5, first, the adhesive layer 3a, the semiconductor chip 5, and a die-bonding film 21 are laminated sequentially on the adherend 6, and temporarily fixed. Further, a spacer 9, the die-bonding film 21, the adhesive layer 3a, and the semiconductor chip 5 are laminated sequentially on the die-bonding film 21, and temporarily fixed.

Next, the wire bonding step is performed as shown in FIG. 5 without performing the heating step. With this, the electrode pad in the semiconductor chip 5 and the adherend 6 are electrically connected by the bonding wire 7.

Next, the sealing step is performed to seal the semiconductor chip 5 with the sealing resin 8, and the sealing resin 8 is cured. At the same time, the adherend 6 and the semiconductor chip 5, and the semiconductor chip 5 and the spacer 9 are fixed by the adhesive layer 3a, 21. With this, a semiconductor package can be obtained. The sealing step is preferably a batch sealing method of sealing only the side of the semiconductor chip 5. The sealing is performed to protect the semiconductor chip 5 that is pasted onto a pressure-sensitive adhesive sheet, and its typical method is molding in a mold using a sealing resin. At that time, it is common to perform the sealing step at once using a mold consisting of a upper mold and a lower mold having a plurality of cavities. The heating temperature during resin sealing is preferably in the range of 170 to 180° C. for example. The post curing step may be performed after the sealing step.

The spacer 9 is not especially limited, and examples that can be used include a conventionally known silicon chip and a polyimide film. Further, a core material may be used as the spacer. The core material is not especially limited, and a conventionally known core material can be used. Specific examples that can be used include a film such as a polyimide film, a polyethylene film, a polyethylene terephthalate film, a polyethylene naphthalate film, and a polycarbonate film, a resin substrate that is reinforced with a glass fiber or a plastic non-woven fiber, a mirror silicon wafer, a silicon substrate, and a glass substrate.

### (Other Items)

In the case where the semiconductor device is three-dimensionally mounted onto the substrate, a buffer coating film is formed on the surface where a circuit of the semiconductor device is formed. Examples of the buffer coating film are a silicon nitride film and a film consisting of a heat resistant resin such as a polyimide resin.

Further, during three-dimensional mounting of the semiconductor device, the die-bonding film that is used in each state is not limited to the one made of the same composition, and it can be suitably changed depending on the manufacturing conditions, uses, etc.

In the above-described embodiment, a mode is described in which the wire bonding step is performed together after laminating a plurality of semiconductor devices on the substrate, etc. However, the present invention is not limited to this. For example, it is possible to perform the wire bonding step every time the semiconductor device is laminated on the substrate, etc.

### EXAMPLES

Below, preferred examples of the present invention are explained in detail. However, materials, addition amounts, and the like described in these examples are not intended to limit the scope of the present invention, and are only examples for explanation as long as there is no description of limitation in particular. In the examples, the word “part(s)” represent “part(s) by weight”, respectively, unless otherwise specified.

### Example 1

An adhesive composition solution having concentration 20% by weight was prepared by dissolving 3 parts of an isocyanate crosslinking agent (Coronate HX manufactured by Nippon Polyurethane Industry Co., Ltd), 12 parts of an epoxy resin (EPIKOTE 1003 manufactured by Japan Epoxy Resins Co., Ltd.), 7 parts of a phenol resin (MILEX XLC-CC manufactured by Mitsui Chemicals, Inc.), and 50 parts of spherical silica (average particle size: 0.5 μm, SS0-25R manufactured by Admatechs) as the inorganic filler to 100 parts of a polymer (Parakuron SN-710 manufactured by Negami Chemical Industrial Co., Ltd.) having butylacrylate as a main component into methylethylketone.

This adhesive composition solution was applied with a fountain coater onto a releasing film consisting of a polyethylene terephthalate film (thickness 50 μm) on which a silicone releasing treatment was performed. The coating was performed to a thickness so that the thickness after drying became 25 μm. Drying of the coating layer on the releasing film was performed. The drying was performed by blowing dry air onto the coating layer. Specifically, hot air was blown onto the coating layer in the MD direction (the film scanning direction of the releasing film) for 3 minutes right after the coating so that the amount of the air became 10 m/min and the temperature became 150° C.

With this, an adhesive layer having an arithmetic mean roughness Ra of 0.34 μm and a thickness of 25 μm was formed on the releasing film. The method of measuring the arithmetic mean roughness Ra was as described later.

Next, production of a die-bonding film was performed. That is, acrylic polymer A having a weight average molecular weight of 850,000 was obtained by placing 88.8 parts of 2-ethylhexyl acrylate (below, referred to as “2EHA”), 11.2 parts of 2-hydroxyethyl acrylate (below, referred to as “HEA”), 0.2 part of benzoyl peroxide, and 65 parts of toluene in a reactor equipped with a cooling tube, a nitrogen-introducing tube, a thermometer, and a stirring apparatus, and performing a polymerization treatment at 61° C. in a nitrogen airflow for 6 hours. The weight average molecular weight is as follows. The molar ratio of 2EHA and HEA was made to be 100 mol:20 mol.

Acrylic polymer A′ was obtained by adding 12 parts (80 mol % to HEA) of 2-methacryloyloxyehyl isocyanate (below, referred to as “MOI”) into this acrylic polymer A and performing an addition reaction treatment at 50° C. in an air flow for 48 hours.

Next, a pressure-sensitive adhesive solution was produced by adding 8 parts of a polyisocyanate compound (trade name “CORONATE L” manufactured by Nippon Polyurethane Industry Co., Ltd.) and 5 parts of a photopolymerization initiator (trade name “IRGACURE 651” manufactured by Chiba Specialty Chemicals) into 100 parts of the acrylic polymer A′.

A pressure-sensitive adhesive layer precursor having a thickness of 10 μm was formed by applying the prepared pressure-sensitive adhesive solution onto the surface of a PET peeling liner where a silicone treatment was performed and heat-crosslinking at 120° C. for 2 minutes. Next, a polyolefin film having a thickness of 100 μm was pasted onto the corresponding surface of the pressure-sensitive adhesive layer precursor. After that, it was kept at 50° C. for 24 hours. After that, the pressure-sensitive adhesive layer was formed by irradiating an ultraviolet ray only onto a portion (diameter 220 mm) corresponding to a semiconductor bonding portion (diameter 200 mm) of the pressure-sensitive adhesive layer precursor. With this, a dicing film was produced having a pressure-sensitive adhesive layer with its arithmetic mean roughness Ra of 0.042 μm. The irradiating condition of the ultraviolet ray was as follows.

### <Irradiating Condition of the Ultraviolet Ray>

Ultraviolet ray (UV) irradiation apparatus: high pressure mercury lamp

Ultraviolet ray cumulative radiation: 500 mJ/cm²

Output: 75 W

Irradiation strength: 150 mW/cm²

Moreover, the ultraviolet ray irradiation was performed directly onto the pressure-sensitive adhesive layer precursor.

Next, the adhesive layer was compressed onto the pressure-sensitive adhesive layer in the dicing film. The compression condition was a lamination temperature of 40° C. and a pressure of 0.2 MPa. With this, a dicing die-bonding film according to the present example was obtained. For evaluation of a peel releasing force, a dicing film was used having a pressure-sensitive adhesive layer with an arithmetic mean roughness of 0.035 μm that was produced with the same method as above.

### Example 2

An adhesive composition solution having concentration 20% by weight was prepared by preparing an acrylic copolymer having 70 parts of 2-ethylhexyl acrylate, 25 parts of n-butyl acrylate, and 5 parts of acrylic acid as constituent monomers and dissolving 3 parts of an isocyanate crosslinking agent (Coronate HX manufactured by Nippon Polyurethane Industry Co., Ltd) and 30 parts of silicon dioxide (average particle size: 0.5 μm, manufactured by Nippon Shokubai Co., Ltd.) as the inorganic filler into methylethylketone.

An adhesive layer was formed by applying this adhesive composition solution onto a releasing film and drying the same as Example 1. The arithmetic mean roughness Ra of this adhesive layer was measured to be 0.16 μm. Further, the dicing die-bonding film according to the present example was produced by bonding with the pressure-sensitive adhesive in the dicing film the same as Example 1.

### Example 3

An adhesive composition solution having concentration 20% by weight was prepared by dissolving 3 parts of an isocyanate crosslinking agent (Coronate HX manufactured by Nippon Polyurethane Industry Co., Ltd), 12 parts of an epoxy resin (EPIKOTE 1003 manufactured by Japan Epoxy Resins Co., Ltd.), 7 parts of a phenol resin (MILEX XLC-CC manufactured by Mitsui Chemicals, Inc.), and 50 parts of spherical silica (average particle size: 0.5 μm, SS0-25R manufactured by Admatechs) as the inorganic filler to 100 parts of a polymer (Parakuron SN-710 manufactured by Negami Chemical Industrial Co., Ltd.) having butylacrylate as a main component into methylethylketone.

This adhesive composition solution was applied with a fountain coater onto a releasing film consisting of a polyethylene terephthalate film (thickness 50 μm) on which a silicone releasing treatment was performed. The coating was performed to a thickness so that the thickness after drying became 25 μm. Drying of the coating layer on the releasing film was performed. The drying was performed by blowing dry air onto the coating layer. Specifically, dry air was blown onto the coating layer in the MD direction for 1 minute right after the coating (initial stage of drying) so that the amount of the air became 10 m/min and the temperature became 90° C. Further, dry air was blown onto the coating layer in the MD direction from 1 to 3 minutes (later stage of drying) so that the amount of the air became 15 m/min and the temperature became 140° C.

With this, an adhesive layer having an arithmetic mean roughness Ra of 0.40 μm and a thickness of 25 μm was formed on the releasing film. The method of measuring the arithmetic mean roughness Ra was as described later.

Next, the dicing film that was used in Example 1 was prepared, and the adhesive layer was compressed onto the pressure-sensitive adhesive layer. The compression condition was a lamination temperature of 40° C. and a pressure of 0.5 MPa. With this, a dicing die-bonding film according to the present example was obtained. For evaluation of a peel releasing force, a dicing film was used having a pressure-sensitive adhesive layer with an arithmetic mean roughness of 0.035 μm that was produced with the same method as above.

### Comparative Example 1

In the present comparative example, a dicing die-bonding film according to the present comparative example was produced in the same manner as Example 1 except that the inorganic filler was not added when preparing the adhesive composition solution. The arithmetic mean roughness Ra in the adhesive layer before bonding to the pressure-sensitive adhesive layer was 0.026 μm.

### Comparative Example 2

In the present comparative example, a dicing die-bonding film according to the present comparative example was produced in the same manner as Example 2 except that the amount of the inorganic filler that was added was made to be 85 parts when preparing the adhesive composition solution. The arithmetic mean roughness Ra in the adhesive layer before bonding to the pressure-sensitive adhesive layer was 1.5 μm.

### (Evaluation of Contact Area)

The contact area between the adhesive layer and the pressure-sensitive adhesive layer in each dicing die-bonding film that was obtained in each example and comparative example was measured as follows.

That is, the contact surface between the adhesive layer and the pressure-sensitive adhesive layer was observed using an optical microscope ECLIPSE ME600 manufactured by Nikon Corporation and an E-410 camera manufactured by OLYMPUS Corporation. The obtained image was binarized using software on the market Winroof (Mitani Corporation), and the distribution state and the area ratio of the region where the adhesive layer did not contact with the pressure-sensitive adhesive layer were calculated. In the image analysis, the measurement was performed on three arbitrary regions, and the averaged value was made to be the contact area. The result is shown in Table 1.

### (Pickup Properties)

Each dicing die-bonding film that was obtained in each example and comparative example was pasted onto the backside of a wafer (diameter 8 inches, thickness 175 μm) at 50° C. The bonding surface of the dicing die-bonding film was made to be the adhesive layer.

Next, the wafer was diced using a dicer. As the dicing condition, the spindle rotation speed was made to be 40,000 rpm and the cutting rate was made to be 30 mm/sec, and semiconductor chips were formed having a 10 mm×10 mm square size.

Next, the pickup of the semiconductor chip was performed, and its success rate was examined. As the pickup condition, the number of needles was made to be 9, the distance of being pulled down was made to be 3 mm, the distance of being pushed up was made to be 300 μm, and the rate of being pushed up was made to be 10 mm/sec. Further, the pickup of 20 semiconductor chips was performed using a pickup apparatus (CPS-100 manufactured by NES Machinery Inc.) For the success rate, the number of semiconductor chips with the die-bonding film that were able to be peeled from the dicing film without damage to the semiconductor chips was counted.

### (Evaluation of Peel Releasing Force)

Each dicing die-bonding film that was obtained in each example and comparative example was pasted onto the backside of a wafer (diameter 8 inches, thickness 75 μm) at 50° C. The bonding surface of the dicing die-bonding film was made to be the adhesive layer.

Next, an evaluation of the peel releasing force was performed by measuring the peeling force when peeling the adhesive layer from the pressure-sensitive adhesive layer in each of the above-described dicing die-bonding films at a peeling rate of 300 mm/min and at 90 degrees at 10 mm width. The result is shown in the following Table 1.

### (Result)

As is obvious from Table 1, chip fly during dicing was not generated and good pickup properties were shown in the dicing die-bonding films in Examples 1 and 2. That is, it was shown that the manufacturing of a semiconductor device is possible with improved yield if it is with the dicing die-bonding film in the present examples.

Contrary to this, in the die-bonding film in Comparative Example 1, because the contact area of the adhesive layer and the pressure-sensitive adhesive layer was too large, the peeling properties with the pressure-sensitive adhesive layer were decreased, the pickup could not be performed, and damage such as cracking and chipping were generated in the chips. Further, in the die-bonding film in Comparative Example 2, because the arithmetic mean roughness of the adhesive layer before bonding to the pressure-sensitive adhesive layer is too large, the adhesion with the pressure-sensitive adhesive layer was poor and chip fly was generated during dicing of a semiconductor wafer.

TABLE 1

| | | | | COMPARATIVE | COMPARATIVE |
|---|---|---|---|---|---|
| | EXAMPLE 1 | EXAMPLE 2 | EXAMPLE 3 | EXAMPLE 1 | EXAMPLE 2 |
| ARITHMETIC MEAN ROUGHNESS | 0.34 | 0.16 | 0.40 | 0.026 | 1.5 |
| OF ADHESIVE LAYER Ra [μm] | | | | | |
| CONTACT AREA [%] | 40.16 | 86.77 | 65.40 | 99.89 | 30.25 |
| PICKUP SUCCESS RATE [%] | 100 | 100 | 100 | 0 | 20 |
| GENERATION OF CHIP FLY | 0 | 0 | 0 | 0 | 14 |
| [chips/8 inch wafer] | | | | | |
| PEEL RELEASING FORCE | 0.04 | 0.09 | 0.06 | 3.8 | 0.01 |
| [N/10 mm] | | | | | |

### EXPLANATION OF THE REFERENCE NUMERALS

1 Base material

2 Pressure-Sensitive Adhesive Layer

3, 3′ Adhesive Layer

5 Semiconductor Chip (Semiconductor Device)

6 Adherend

7 Bonding Wire

8 Sealing Resin

9 Spacer

10, 11 Dicing Die-bonding film

13, 21 Adhesive Layer

15 Semiconductor Chip (Semiconductor Device)

1. A method of manufacturing a dicing die-bonding film comprising a pressure-sensitive adhesive layer and an adhesive layer laminated sequentially on a base material, the method including the steps of:
forming the adhesive layer on a releasing film, the film containing an inorganic filler, having an arithmetic mean roughness Ra of 0.015 to 1 μm, and having an uneven surface and
bonding the pressure-sensitive adhesive layer and the adhesive layer provided on the base material under the conditions of a temperature of 30 to 50° C. and a pressure of 0.1 to 0.6 MPa and making the contact area of the pressure-sensitive adhesive layer and the adhesive layer be in the range of 35 to 90% to the bonding area.

2. The method of manufacturing a dicing die-bonding film according to claim 1, wherein the step of forming the adhesive layer including the steps of:
forming a coating layer by applying an adhesive composition solution containing the inorganic filler on the releasing film and
drying by blowing dry air having an amount of air of 5 to 20 m/min onto the coating layer under conditions of a drying temperature of 70 to 160° C. and a drying time of 1 to 5 min.

3. The method of manufacturing the dicing die-bonding film according to claim 2, wherein the mixing amount of the inorganic filler is 20 to 80 parts by weight to 100 parts by weight of an organic resin component in the adhesive layer.

4. The method of manufacturing the dicing die-bonding film according to claim 1, wherein the inorganic filler having an average particle size of 0.1 to 5 μm is used.

5. The method of manufacturing the dicing die-bonding film according to claim 2, wherein the drying of the coating layer is performed by increasing the drying temperature gradually as the drying time passes.

6. The method of manufacturing the dicing die-bonding film according to claim 1, wherein the arithmetic mean roughness Ra of the pressure-sensitive adhesive layer before bonding to the adhesive layer is in the range of 0.015 to 0.5 μm.

7. A dicing die-bonding film comprising a pressure-sensitive adhesive layer and an adhesive layer sequentially laminated on a base material, wherein
the adhesive layer contains an inorganic filler, has an uneven bonding surface before bonding to the pressure-sensitive adhesive layer, and has an arithmetic mean roughness Ra is 0.015 of 1 μm, and wherein
the contact area of the bonding surface is in the range of 35 to 90% to the bonding surface.

8. The dicing die-bonding film according to claim 7, wherein the mixing amount of the inorganic filler is 20 to 80 parts by weight to 100 parts by weight of an organic resin component in the adhesive layer.

9. The dicing die-bonding film according to claim 7, wherein the inorganic filler having an average particle size of 0.1 to 5 μm is used.

10. The dicing die-bonding film according to claim 7, wherein the arithmetic mean roughness Ra of the pressure-sensitive adhesive layer before bonding to the adhesive layer is in the range of 0.015 to 0.5 μm.

11. The method of manufacturing the dicing die-bonding film according to claim 1, wherein the pressure-sensitive adhesive layer comprises a radiation curable pressure sensitive adhesive.

12. The method of manufacturing the dicing die-bonding film according to claim 1, wherein the pressure-sensitive adhesive layer possesses an adhesive power of 0.04 to 0.2 N/10 mm.

13. The method of manufacturing the dicing die-bonding film according to claim 1, wherein the adhesive layer possesses a tensile storage elastic modulus at 120° C. before curing of 1×10⁴ Pa or more.

14. The dicing die-bonding film according to claim 7, wherein the pressure-sensitive adhesive layer comprises a radiation curable pressure sensitive adhesive.

15. The dicing die-bonding film according to claim 7, wherein the pressure-sensitive adhesive layer possesses an adhesive power of 0.04 to 0.2 N/10 mm.

16. The dicing die-bonding film according to claim 7, wherein the adhesive layer possesses a tensile storage elastic modulus at 120° C. before curing of 1×10⁴ Pa or more.
